(19) United States
(12) Patent Application Publication
(10) Pub. No.: US 2026/0200119 A1
(43) Pub. Date: Jul. 16, 2026

(54) PERFORATING DEVICE, POST-PROCESSING DEVICE AND IMAGE FORMING SYSTEM

(71) Applicant: Konica Minolta, Inc., Tokyo (JP)

(72) Inventor: Shota KURAMOCHI, Okazaki-shi (JP)

(21) Appl. No.: 19/448,257

(22) Filed: Jan. 14, 2026

(30) Foreign Application Priority Data
Jan. 14, 2025 (JP) 2025-005049

(51) Int. Cl. B26F 1/14; G03G 15/00

(52) U.S. Cl. CPC B26F 1/14; G03G 15/6582; G03G 2215/00818

(57) ABSTRACT

A perforating device includes a punch die that forms part of a conveyance route through which a recording medium is conveyed, a punch provided to correspond to the punch die, and a thermal insulating sheet that covers at least part of a surface of the punch die.

### CROSS REFERENCE TO RELATED APPLICATIONS

The present invention claims priority under 35 U.S.C. § 119 to Japanese Application No. 2025-005049 filed on Jan. 14, 2025, the entire contents of which being incorporated herein by reference.

### BACKGROUND OF THE INVENTION

### Technical Field

The present invention relates to a perforating device, a post-processing device and an image forming system. In particular, the present invention relates to a perforating device that perforates a recording medium, a post-processing device including the perforating device, and an image forming system including the post-processing device.

### Description of Related Art

An image forming apparatus represented by a Multi Function Peripheral (MFP) transfers a toner image onto a sheet using toner and heats the sheet together with the toner, thereby fixing the toner image onto the sheet. Therefore, the sheet discharged from the MFP has a temperature higher than room temperature. A post-processing device may be mounted downstream of the MFP. The post-processing device executes post-processing such as punch processing for perforating a sheet on which an image is formed by the MFP and staple processing for bundling a plurality of sheets. This post-processing device includes with a punch and a punch die formed of metal or the like in order to perforate a sheet. In a period during which a sheet having a high temperature passes through the punch die, water vapor generated from the sheet may condense on the punch die. In this case, water droplets may adhere to the sheet. When water droplets adhere to the sheet, the sheet may be wrinkled. It may result in degradation of quality of output matter. In addition, the frictional force between sheets to which water droplets adhere is increased. Therefore, there is a problem that it is difficult to stack and align a plurality of sheets.

Japanese Unexamined Patent Application Publication No. H 6-35360 describes a fixing apparatus of an electrophotographic recording device formed of a fixing device that fixes a toner image of a medium with heat and a medium conveyance path downstream of the fixing device, being characterized in that a moisture absorbing member is provided in the conveyance path.

However, in a case in which the moisture absorbing member is arranged in the conveyance path, the width of the conveyance path corresponding to a punch die must be increased by the thickness of the moisture absorbing member. Therefore, the length of a punch stroke is increased. Therefore, there is a problem that the size of the apparatus is increased. Further, even when the moisture absorbing member absorbs water vapor, all of the moisture included in a sheet is not absorbed, and moisture included in a high-temperature sheet discharged from the electrophotographic recording device cannot be removed. For this reason, it is not possible to prevent condensation in the post-processing device provided downstream of the electrophotographic recording device.

### SUMMARY OF THE INVENTION

According to one aspect of the present invention, a perforating device includes a punch die that forms part of a conveyance route through which a recording medium is conveyed, a punch provided to correspond to the punch die, and a thermal insulating sheet that covers at least part of a surface of the punch die.

According to another aspect of the present invention, a post-processing device includes the above-mentioned perforating device, and a processing device that is arranged downstream of the perforating device and processes a stack of a plurality of recording media.

According to yet another aspect of the present invention, an image forming system includes the above-mentioned post-processing device, and an image forming apparatus arranged upstream of the perforating device, wherein the image forming apparatus includes an image forming section that forms an image on a recording medium, and a heating section that heats the recording medium on which an image is formed by the image forming section.

### BRIEF DESCRIPTION OF THE DRAWINGS

The advantages and features provided by one or more embodiments of the invention will become more fully understood from the detailed description given hereinbelow and the appended drawings which are given by way of illustration only and thus are not intended as a definition of the limits of the present invention.

FIG. 1 is a cross-sectional view schematically illustrating one example of the inner configuration of an image forming system according to one embodiment of the present invention;

FIG. 2 is an enlarged view of the inner configuration of a post-processing device;

FIG. 3 is a cross-sectional view illustrating one example of the inner configuration of a punching unit;

FIG. 4 is a partially enlarged view of FIG. 3;

FIG. 5 is an enlarged view of a thermal insulating sheet;

FIG. 6 is a diagram of a first die as viewed from below; and

FIG. 7 is an enlarged cross-sectional view of a connection portion between a first upper guide portion and the first die.

### DETAILED DESCRIPTION

Hereinafter, one or more embodiments of the present invention will be described with reference to the drawings. However, the scope of the invention is not limited to the disclosed embodiments.

Embodiments of the present invention will be described below with reference to the drawings. In the following description, the same components are denoted by the same reference numerals. Their names and functions are also the same. Therefore, a detailed description thereof will not be repeated.

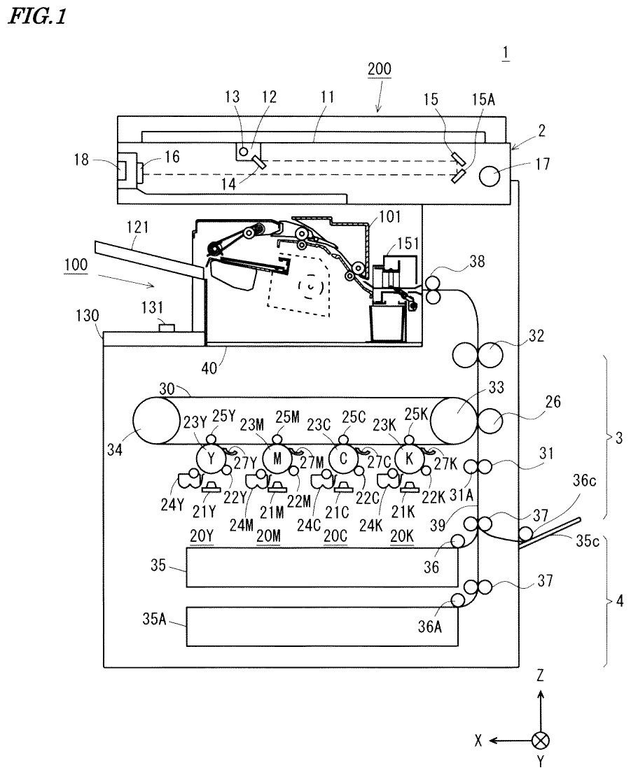

FIG. 1 is a cross-sectional view schematically illustrating one example of the inner configuration of an image forming system in one embodiment of the present invention. With reference to FIG. 1, the image forming system 1 includes an MFP 200 and a post-processing device 100. An Multi Function Peripheral (MFP) 200 is one example of an image forming apparatus. The post-processing device 100 is attachable to and detachable from the MFP 200. Here, an X-direction, a Y-direction and a Z-direction which are orthogonal to one another are defined. The X direction and the Y direction are parallel to a horizontal plane. In the Y direction, a direction directed from a rear surface toward a front surface of the MFP 200 (a direction directed from a positive position toward a negative position in the Y direction) is referred to as a front-surface direction, and a horizontal direction directed from the front surface toward the rear surface (a direction directed from a negative position toward a positive position in the Y direction) is referred to as a rear-surface direction.

The MFP 200 includes a document reading section 2 for reading a document, an image forming section 3 for forming an image on a sheet based on image data, a sheet feed section 4 for supplying a sheet to the image forming section 3 and a post-processing device 100 for executing post-processing on a sheet on which an image is formed.

The document reading section 2 exposes an image of a document set on a document glass 11 with an exposure lamp 13 attached to a slider 12 moving below the document glass 11. The light reflected from the document is guided to a lens 16 by a mirror 14 and two reflecting mirrors 15, 15A, and forms an image on a Charge Coupled Device (CCD) sensor 18.

The reflected light that has formed an image on the CCD sensor 18 is converted into image data as an electric signal in the CCD sensor 18. The image data is converted into printing data of cyan (C), magenta (M), yellow (Y) and black (K) and is output to the image forming section 3.

The image forming section 3 includes respective image forming units 20Y, 20M, 20C, 20K for respective yellow, magenta, cyan and black. Here, “Y,” “M,” “C” and “K” represent yellow, magenta, cyan and black, respectively. An image is formed by driving of at least one of the image forming units 20Y, 20M, 20C, 20K. When all of the image forming units 20Y, 20M, 20C, 20K are driven, a full-color image is formed. Printing data pieces for yellow, magenta, cyan and black are respectively input to the image forming units 20Y, 20M, 20C, 20K. The only difference among the image forming units 20Y, 20M, 20C, 20K is the colors of toners used by the image forming units 20Y, 20M, 20C, 20K. Therefore, the image forming unit 20Y for forming an image in yellow will be described here.

The image forming unit 20Y includes an exposure device 21Y, a photosensitive drum 23Y, a charging roller 22Y, a developing device 24Y and a primary transfer roller 25Y. Around the photosensitive drum 23Y, the charging roller 22Y, the exposure device 21Y, the developing device 24Y, the primary transfer roller 25Y and a drum cleaning blade 27Y are arranged in this order in a rotation direction of the photosensitive drum 23Y. The yellow printing data piece is input to the exposure device 21Y. The photosensitive drum 23Y is an image bearing member. The charging roller 22Y uniformly charges the surface of the photosensitive drum 23Y. The primary transfer roller 25Y transfers a toner image formed on the photosensitive drum 23Y onto an intermediate transfer belt 30, serving as an image bearing member, using the effect of an electric field force.

After being electrically charged by the charging roller 22Y, the photosensitive drum 23Y is irradiated with laser light emitted by the exposure device 21Y. The exposure device 21Y exposes a portion corresponding to the image on the surface of the photosensitive drum 23Y. Thus, an electrostatic latent image is formed on the photosensitive drum 23Y. Subsequently, the developing device 24Y develops the electrostatic latent image formed on the photosensitive drum 23Y with the charged toner. Specifically, toner is placed on the electrostatic latent image formed on the photosensitive drum 23Y due to the effect of an electric field force, so that the toner image is formed on the photosensitive drum 23Y. The toner image formed on the photosensitive drum 23Y is transferred onto the intermediate transfer belt 30 serving as an image bearing member by the primary transfer roller 25Y with use of the effect of an electric field force. The toner remaining on the photosensitive drum 23Y without being transferred is removed from the photosensitive drum 23Y by the drum cleaning blade 27Y.

The intermediate transfer belt 30 is suspended by a driving roller 33 and a driven roller 34 so as not to loosen. When the driving roller 33 is rotated in a counterclockwise direction in the diagram, the intermediate transfer belt 30 is rotated in the counterclockwise direction in the diagram at a predetermined speed. The driven roller 34 is rotated in the counterclockwise direction in accordance with the rotation of the intermediate transfer belt 30.

Thus, the image forming units 20Y, 20M, 20C, 20K sequentially transfer toner images onto the intermediate transfer belt 30. Timing for transferring toner images onto the intermediate transfer belt 30 by the respective image forming units 20Y, 20M, 20C, 20K is adjusted based on detection of a reference mark provided on the intermediate transfer belt 30. Thus, toner images in yellow, magenta, cyan and black are superimposed on the intermediate transfer belt 30.

A toner image formed on the intermediate transfer belt 30 is transferred onto a sheet with the effect of an electric field force by the secondary transfer roller 26 serving as a transfer member. A sheet conveyed by the timing roller 31 is conveyed to a nip portion in which the intermediate transfer belt 30 and a secondary transfer roller 26 come into contact with each other. The sheet to which the toner image is transferred is conveyed to a fixing roller 32 to be heated and pressurized by the fixing roller 32. Thus, toner is fused and fixed to the sheet. At this stage, the temperature of the sheet is higher than room temperature. Thereafter, the sheet is conveyed to the post-processing device 100 by a discharge roller 38.

In sheet feed cassettes 35, 35A, sheets in different sizes are respectively set. The sheets respectively stored in the sheet feed cassettes 35, 35A are supplied to a conveyance route 39 by pickup rollers 36, 36A respectively attached to the sheet feed cassettes 35, 35A and are sent to a timing roller 31 by a sheet feed roller 37.

While driving all of the image forming units 20Y, 20M, 20C, 20K in a case of forming a full-color image, the MFP 200 drives any one of the image forming units 20Y, 20M, 20C, 20K in a case of forming a monochrome image. It is also possible to form an image by combining two or more of the image forming units 20Y, 20M, 20C, 20K. Here, the MFP 200 uses a tandem-system including the image forming units 20Y, 20M, 20C, 20K that respectively form toner images in four colors on a sheet, by way of example. However, the MFP 200 may use a four-cycle system that sequentially transfers the toner images in four colors onto a sheet using one photosensitive drum.

The post-processing device 100 is arranged in a housing space between the image forming section 3 and the document reading section 2 of the MFP 200. The post-processing device 100 is arranged on a slide surface 40 that is an upper surface of a top plate of a housing that accommodates the image forming section 3, so as to be slidable in the X direction. The post-processing device 100 has a main body rear portion 130 that projects in a positive X direction from the main body portion. An operation lever 131 is provided on the upper surface of the main body rear portion 130 serving as an operation surface. When a user slides the operation lever 131 in the positive X direction, it releases the lock, and the post-processing device 100 slides in the positive X direction on the slide surface 40. Thus, the post-processing device 100 is detached from the MFP 200.

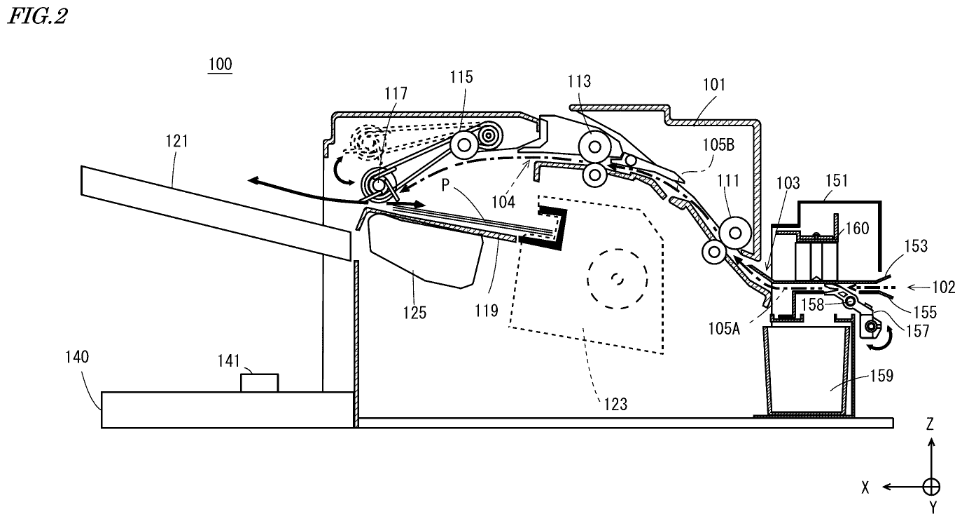

FIG. 2 is an enlarged view of the inner configuration of the post-processing device. With reference to FIG. 2, the post-processing device 100 includes a stapling unit 101 and a punching unit 151. The stapling unit 101 is one example of a processing device. The punching unit 151 is one example of a perforating device. The punching unit 151 is attachable to and detachable from the stapling unit 101.

The punching unit 151 includes an upper guide plate 153, a lower guide plate 155, a punching mechanism 160, a restricting member 157 and a scrap storage 159. The upper guide plate 153 and the lower guide plate 155 are provided to face each other in an upward-and-downward direction.

Respective facing surfaces of the upper guide plate 153 and the lower guide plate 155 form a conveyance route 105A. The upper guide plate 153 and the lower guide plate 155 are arranged with a predetermined clearance therebetween. The upstream end of the conveyance route 105A is an insertion port 102, and the downstream end of the conveyance route 105A is a coupling port 103. The insertion port 102 is connected to the end of the conveyance route through which a sheet is conveyed in the MFP 200. The coupling port 103 is connected to a conveyance route 105B of the stapling unit 101.

The restricting member 157 and the punching mechanism 160 are arranged between the insertion port 102 and the coupling port 103 of the conveyance route 105A. The scrap storage 159 is arranged below the punching mechanism 160.

The restricting member 157 is rotatably connected to a rotation shaft 158. The rotation shaft 158 is fixed to a frame of the punching unit 151 at a position that is predetermined with respect to the punching mechanism 160. The diagram illustrates the restricting member 157 having a first posture. The restricting member 157 has a jaw portion in which a recess is formed at the upper end. The jaw portion has an abutment surface facing downstream in a conveyance direction. The restricting member 157 can change its posture between the first posture and a second posture by rotating about the rotation shaft 158. In the first posture, the jaw portion of the restricting member 157 closes the conveyance route 105A. With the second posture, at least part of the conveyance route 105A has a clearance.

In the stapling unit 101, the conveyance route 105B is formed in a main body housing. The conveyance route 105B connects the coupling port 103 to a discharge port 104. The coupling port 103 is shared with the punching unit 151 with the punching unit 151 coupled to the stapling unit 101. The direction from the coupling port 103 toward the discharge port 104 is the conveyance direction in which a sheet is conveyed. A forward-reverse roller 111 and a conveyance roller 113 are arranged in this order in the conveyance direction on the conveyance route 105B between the coupling port 103 and the discharge port 104. The forward-reverse roller 111 is arranged at a predetermined distance from the coupling port 103. A motor that transmits a rotational force to the forward-reverse roller 111 rotates the forward-reverse roller 111 in one of a forward direction and a reverse direction. In a case in which the forward-reverse roller 111 rotates in the forward direction, a sheet is conveyed by the forward-reverse roller 111 in the conveyance direction directed from the punching unit 151 toward the conveyance roller 113. In a case in which the forward-reverse roller 111 rotates in the reverse direction, a sheet is conveyed by the forward-reverse roller 111 in the opposite direction directed from the conveyance roller 113 toward the punching unit 151.

A sheet conveyed by the discharge roller 38 of the MFP 200 enters the conveyance route 105A from the insertion port 102 and is conveyed through the conveyance route 105A. The sheet abuts against the restricting member 157 in a period during which being conveyed through the conveyance route 105A. The restricting member 157 having the first posture rotates about the rotation shaft 158 in response to receiving a force from the sheet, and changes its posture to the second posture. The sheet conveyed by the discharge roller 38 is conveyed through the conveyance route 105A and enters the conveyance route 105B through the coupling port 103, and the leading end of the sheet reaches the forward-reverse roller 111. The sheet that has reached the forward-reverse roller 111 is conveyed by the forward-reverse roller 111. The forward-reverse roller 111 rotates in the forward direction until the trailing end of the sheet passes through the restricting member 157. When the trailing end of the sheet passes through the restricting member 157, the restricting member 157 no longer receives a force from the sheet. Therefore, the sheet is rotated by its own weight and returns to have the first posture.

The forward-reverse roller 111 rotates in the reverse direction after the trailing end of the sheet passes through the restricting member 157. The forward-reverse roller 111 conveys the sheet in the opposite direction, causes the trailing end of the sheet to abut against an abutment surface included in the restricting member 157, and stops rotating. Thus, the sheet is positioned with respect to the punching mechanism 160. When the punching mechanism 160 works with the sheet being positioned with respect to the punching mechanism 160, a punch hole is formed in the sheet. The forward-reverse roller 111 rotates in the forward direction after the punching mechanism 160 works. Thus, the sheet is conveyed through the conveyance route 105B toward a discharge roller 115.

The stapling unit 101 includes a conveyance roller 113 and a paddle 117. The conveyance roller 113 is arranged downstream of the forward-reverse roller 111 in the conveyance route 105. The paddle 117 is arranged in a space downstream of the discharge port 104 that is the end of the conveyance route 105. An alignment section 119 is arranged below the paddle 117. A stapler 123 is arranged adjacent to one end of the alignment section 119. A discharge device 125 is arranged below the alignment section 119.

The sheet conveyed by the conveyance roller 113 is conveyed toward the discharge port 104. The paddle 117 is movable in the upward-and-downward direction. In a period during which the sheet is conveyed through the conveyance route 105B by the conveyance roller 113, the paddle 117 is located at an upper position, and a space is formed downstream of the discharge port 104. Therefore, the sheet is conveyed by the conveyance roller 113 with its leading end directed toward a sheet ejection tray 121, and is discharged to the space downstream of the discharge port 104. When the trailing end of the sheet conveyed by the conveyance roller 113 passes through the discharge port 104, the paddle 117 moves downwardly. As the paddle 117 is lowered, the sheet is lowered toward the alignment section 119. The paddle 117 is driven by a belt to rotate counterclockwise in the diagram. Thus, the sheet held between the paddle 117 and the alignment section 119 is conveyed in a direction opposite to the conveyance direction. The sheet receives a force directed in a negative X direction by the paddle 117 on the alignment section 119, and is positioned by abutting against a locking portion 119A of the alignment section 119. The alignment section 119 includes an alignment plate that aligns positions of a plurality of sheets stacked on the alignment section 119 in the Y direction.

The stapler 123 staples a stack of the plurality of sheets placed on the alignment section 119. Thus, the stack of the plurality of sheets is stapled. Hereinafter, a stapled set of a plurality of sheets is referred to as a booklet. The booklet on the alignment section 119 is discharged to the sheet ejection tray 121 by the discharge device 125.

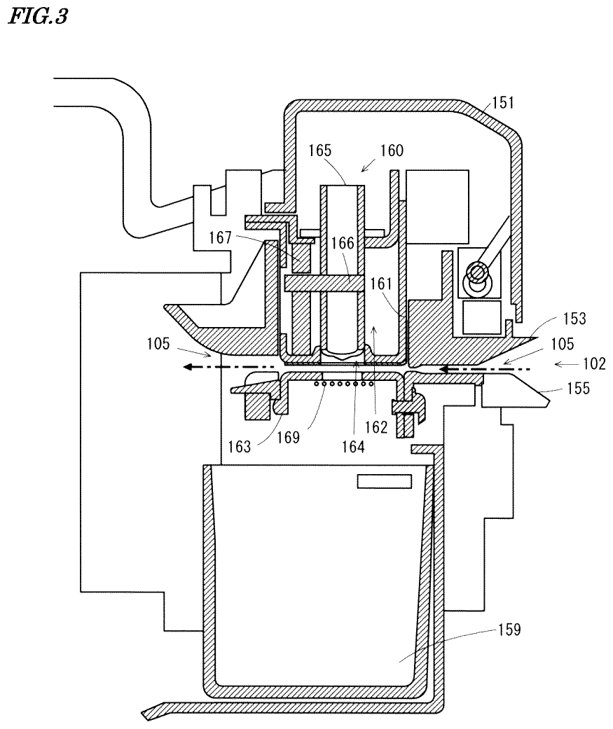

FIG. 3 is a cross-sectional view illustrating one example of the inner configuration of the punching unit. With reference to FIG. 3, the punching unit 151 includes the upper guide plate 153, the lower guide plate 155, the punching mechanism 160, and the scrap storage 159 arranged below the punching mechanism 140. The scrap storage 159 is a an open-top box having a rectangular parallelepiped shape. When the punching mechanism 160 perforates a sheet, punch scraps are generated by cutting the sheet and fall from the punching mechanism 140. Therefore, the scrap storage 159 stores the punch scraps.

The punching mechanism 160 perforates a sheet. The punching mechanism 160 includes a first die 161, a second die 163, a punching shaft 165 and a cam plate 167. The first die 161, the second die 163 and the punching shaft 165 are formed of metal. The first die 161 is part of the upper guide plate 153. The second die 163 is part of the lower guide plate 155. The first die 161 and the second die 163 are arranged to be opposite to each other with the conveyance route 105A interposed therebetween. The first die 161 is arranged above the conveyance route 105A, and the second die 163 is arranged below the conveyance route 105A.

The punching shaft 165 has a cylindrical shape, and a punching blade is formed at the lower end of the punching shaft 165. A plurality of punching shafts 165 are arranged side by side in the Y direction. Each of the plurality of punching shafts 165 is arranged at the frame of the punching mechanism 160 while being reciprocatable in a direction parallel to one direction with its axial center being parallel to the one direction. In the present embodiment, the one direction is the Z direction, and five punching shafts 165 are installed. All of the five punching shafts 165 have the same configuration. A slide member extending in a direction orthogonal to the axial center is coupled to the punching shaft 165. The slide member has a columnar shape, and the rotationally symmetric axis of the slide member is orthogonal to the axial center of the punching shaft 165.

The cam plate 167 is a flat plate having a reference surface parallel to the axial center of the punching shaft 165, and is formed with a cam groove orthogonal to the reference surface. The slide member of the punching shaft 165 is inserted in the cam groove formed in the cam plate 167. The width of the cam groove in a direction parallel to the axial center of the punching shaft 165 (vertical direction) is equal to or slightly larger than the outer diameter of the slide member. The cam plate 167 is arranged at the frame of the punching unit 151 while being reciprocatable in a horizontal direction parallel to the axial center of the punching shaft 165, which is the Y direction in the present embodiment. A drive mechanism causes the cam plate 167 to reciprocate. The drive mechanism is a combination of a motor serving as a drive source, and a rack and pinion mechanism. The drive mechanism causes the cam plate 167 to reciprocate in the horizontal direction (Y direction) parallel to the axial center of the punching shaft 165. The slide member coupled to the punching shaft 165 slides in the cam groove, and the punching shaft 165 reciprocates in a direction parallel to the axial center. In the present embodiment, the axial center of the punching shaft 165 reciprocates in a direction parallel to the Z direction. Further, the punching shaft 165 penetrates a through hole formed in the second die 163 as the punching shaft 165 is lowered, so that a sheet is perforated.

In the first die 161, a first through hole 162 is formed at a position corresponding to the punching shaft 165. In a second die 163, a second through hole 164 corresponding to the punching shaft 165 is formed. The first through hole 162 guides the punching shaft 165 when the punching shaft 165 reciprocates in the Z direction. When entering the second through hole 164 formed in the second die 163, the punching shaft 165 perforates a sheet. A plurality of discharging sections 169 are arranged below the second through hole 164 of the second die 163. Part of the discharging sections 169 overlaps with the second through hole 164 in the Z direction. The discharging sections 169 are formed of an elastic material and have conductivity. After penetrating the second through hole 164, the punching shaft 165 comes into contact with the discharging sections 169. Thus, static electricity is discharged. Therefore, static electricity is removed from punch scraps of a sheet, so that the punch scraps are likely to fall.

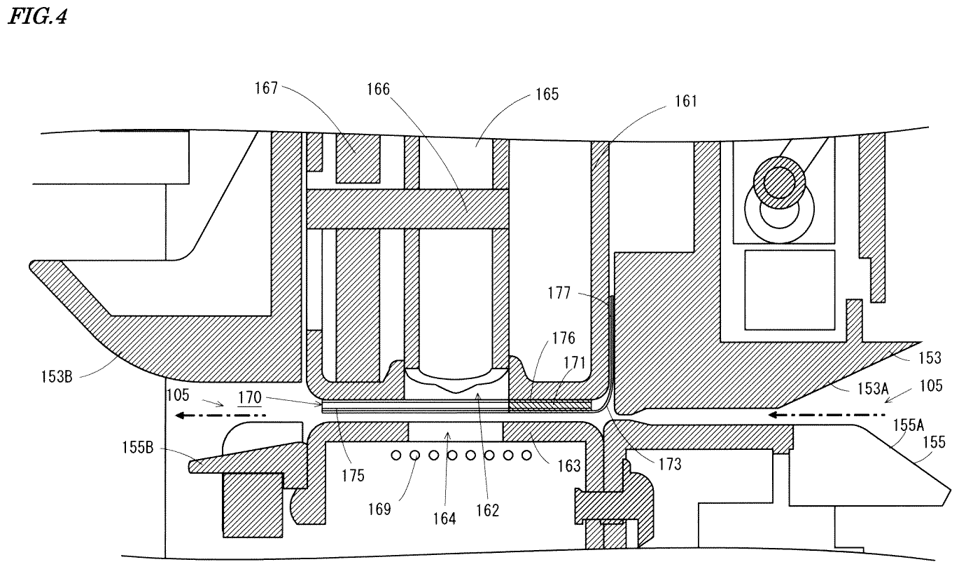

FIG. 4 is a partially enlarged view of FIG. 3. In FIG. 4, the vicinity of the conveyance route 105A is illustrated in an enlarged manner. With reference to FIG. 4, the upper guide plate 153 includes a first upper guide portion 153A, the first die 161 and a second upper guide portion 153B. The first upper guide portion 153A arranged upstream of the first die 161, and the second upper guide portion 153B is arranged downstream of the first die 161. The first die 161 is arranged between the first upper guide portion 153A and the second upper guide portion 153B in the conveyance direction. The lower guide plate 155 includes a first lower guide portion 155A, the second die 163 and a second lower guide portion 155B. The first lower guide portion 155A is arranged upstream of the second die 163, and the second lower guide portion 155B is arranged downstream of the second die 163. The second die 163 is arranged between the first lower guide portion 155A and the second lower guide portion 155B in the conveyance direction.

The surface of the first die 161 facing the second die 163 forms part of the conveyance route 105. A thermal insulating sheet 170 is arranged on the surface of the first die 161 facing the second die 163.

FIG. 5 is an enlarged view of the thermal insulating sheet. With reference to FIG. 5, the thermal insulating sheet 170 includes a thermal insulating layer 171, a low-friction layer 173, a first adhesive layer 175 and a third adhesive layer 177. The thermal insulating sheet 170 has a two-layer structure in which the thermal insulating layer 171 and the low-friction layer 173 are bonded together with the first adhesive layer 175. The thermal insulating layer 171 is made of a material having a thermal insulating property. The low-friction layer 173 is made of a material having a small friction coefficient. In the present embodiment, the thermal insulating layer 171 is made of a nonwoven fabric, and the low-friction layer 173 is made of polyethylene terephthalate (PET). Further, the low-friction layer 173 may be formed of resin having low thermal conductivity. In this case, because the low-friction layer 173 has a thermal insulating property, the thermal insulating layer 171 is not necessary.

In the present embodiment, the thickness of the thermal insulating layer 171 is equal to or greater than 0.25 mm, and equal to or less than 1.0 mm. Preferably, the thickness of the thermal insulating layer 171 is 0.25 mm. The thickness of the low-friction layer 173 is equal to or greater than 0.1 mm, and is equal to or less than 0.25 mm. Preferably, the thickness of the low-friction layer 173 is 0.1 mm. The distance between the first die 161 and the second die 163 is 2.0 mm. Therefore, because the thickness of the thermal insulating sheet 170 can be reduced, it can suppress an increase in size of the punching unit 151.

With reference to FIG. 4 and FIG. 5, the thermal insulating layer 171 is attached to the surface of the first die 161 facing the second die 163 by the second adhesive layer 176. The low-friction layer 173 includes an extension portion that extends along the side surface upstream of the first die 161. The extension portion does not overlap with the thermal insulating layer 171. The upstream end of the low-friction layer 173 is attached to the side surface upstream of the first die 161 by the third adhesive layer 177. This facilitates work for attaching the thermal insulating sheet 170 to the first die 161.

With the thermal insulating sheet 170 attached to the first die 161, the surface of the extension portion of the low-friction layer 173 facing the conveyance route 105 extends in a direction parallel to the conveyance direction, then is curved upwardly and becomes parallel to the side surface upstream of the first die 161. Therefore, the thermal insulating sheet 170 has a shape such that the farther a portion of the thermal insulating sheet 170 is located away from the surface of the first die 161 in the upstream direction, the farther the portion of the thermal insulating sheet 170 is located away from the surface of the second die 163 in a direction orthogonal to the surface of the first die 161 facing the second die 163. Therefore, even when the leading end of a sheet conveyed through the conveyance route 105 abuts against the low-friction layer 173, a downward force is exerted on the leading end of the sheet. Therefore, it is possible to minimize a force, which the low-friction layer 173 receives when the leading end of the sheet collides with the low-friction layer 173. Further, because a force that causes the leading end of the sheet to be directed downwardly is exerted, the sheet can be guided in a direction such that the sheet advances through the conveyance route 105. Further, because the low-friction layer 173 has a friction coefficient lower than that of the thermal insulating layer 171, a paper jam can be suppressed even when the low-friction layer 173 comes into contact with a sheet.

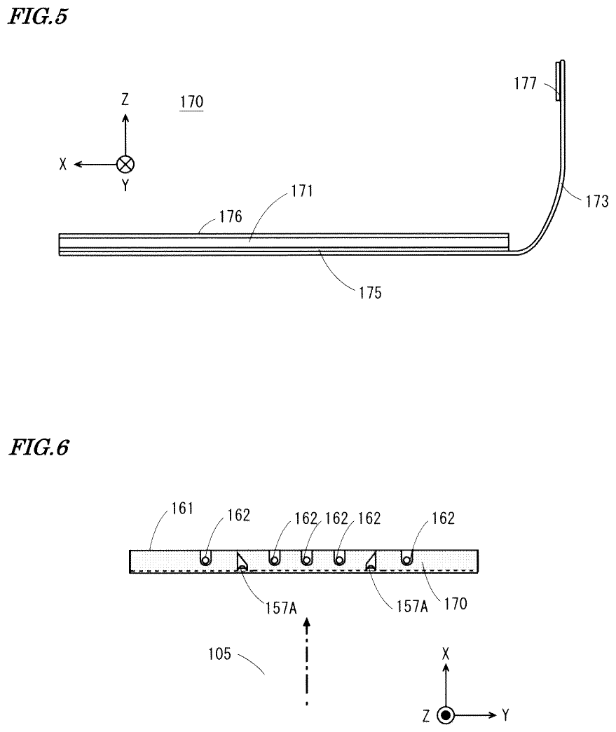

FIG. 6 is a diagram of the first die as viewed from below. In FIG. 6, the sheet conveyance direction is indicated by the one dot chain arrow. With reference to FIG. 6, the thermal insulating sheet 170 covers the area of the surface of the first die 161 facing the second die 163 except for a non-thermal insulating area portion, with the non-thermal insulating area portion including the first through holes 162 and the area downstream of the first through holes 162 in the conveyance direction.

In the portions of the thermal insulating sheet 170 corresponding to the first through holes 162, the leading end of a sheet may move toward the first through holes 162. In this case, when the thermal insulating sheet 170 is present downstream of the first through holes 162, the leading end of the sheet may abut against the thermal insulating sheet 170. Because the area downstream of the first through holes 162 is set as the non-thermal insulating area, the leading end of the sheet is less likely to abut against the thermal insulating sheet 170. This suppresses a paper jam.

The first die 161 has a cutout 157A, which part of the restricting member 157 enters, so as not to interfere with the restricting member 157 having the first posture. The thermal insulating sheet 170 is not attached to the portion of the cutout 157A.

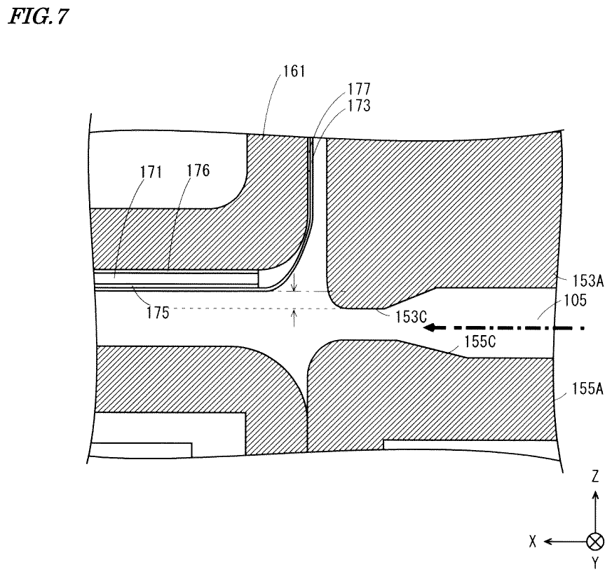

FIG. 7 is an enlarged cross-sectional view of a connection portion between the first upper guide portion and the first die. With reference to FIG. 7, the first upper guide portion 153A has a first conveyance surface 153C forming part of the conveyance route 105. The first lower guide portion 155A has a second conveyance surface 155C forming part of the conveyance route 105. The first conveyance surface 153C and the second conveyance surface 155C face each other.

The lowermost end of the first conveyance surface 153C is located below the lowermost end of the thermal insulating sheet 170. Therefore, the leading end of a sheet that has passed between the upper guide plate 153 and the lower guide plate 155 is unlikely to collide with the thermal insulating sheet 170. This suppresses damage to the thermal insulating sheet 170.

As described above, the punching unit 151 in the present embodiment includes the thermal insulating layer 171 that covers at least part of the surface of the first die 161 facing the second die 163. The first die 161, the second die 163 and the punching shaft 165 are formed of metal, thereby having relatively high thermal conductivity. Therefore, even in a case in which a sheet heated by the MFP 200 is conveyed through the conveyance route 105A, an occurrence of condensation on the surface of the first die 161 is suppressed. This suppresses adhesion of water droplets to the sheet.

Further, the thermal insulating sheet 170 is attached to the first die 161 arranged above the second die 163. Because water vapor generated from a sheet is likely to move upwardly, the thermal insulating sheet is arranged on the first die 161 located above the sheet. Therefore, it is not necessary to arrange a thermal insulator in the second die 163. Thus, the configuration can be simplified, and the cost can be reduced. Because water vapor moves upwardly, it is sufficient to attach the thermal insulating sheet 170 to the first die 161 located above a sheet.

Further, the thermal insulating sheet 170 has a shape such that the farther a portion of the thermal insulating sheet 170 is located upstream and away from the surface of the first die 161 facing the second die 163 in the sheet conveyance direction, the farther the portion of the thermal insulating sheet 170 is located away from the surface in a direction orthogonal to the surface. In a case in which a sheet being conveyed enters the conveyance route formed of the first die 161, even when the leading end of the sheet comes into contact with the thermal insulating sheet 170, the resistance that the sheet receives from the thermal insulating sheet 170 can be reduced. This suppresses damage to the thermal insulating sheet 170. Further, this suppresses a paper jam.

Further, the thermal insulating sheet 170 covers an area of the surface of the first die 161 facing the second die 163 except for a non-thermal insulating area portion, with the non-thermal insulating area portion including the first through holes 162 corresponding to the punching shafts 165 of the first die 161 and a downstream portion located downstream of the first through holes 162 in the sheet conveyance direction. Because the thermal insulating sheet 170 does not cover the first through holes 162 and the downstream portion, it is possible to suppress an occurrence of an event in which a sheet is caught by the thermal insulating sheet 170. This can suppress a paper jam.

Further, the thermal insulating sheet 170 has a two-layer structure in which the thermal insulating layer 171, and the low-friction layer 173 having a friction coefficient smaller than that of the thermal insulating layer 171 are stacked. Therefore, in a case in which a sheet comes into contact with the thermal insulating sheet 170, the thermal insulating layer 171 can block heat, and the frictional resistance between the low-friction layer 173 and the sheet can be reduced as much as possible.

Further, the first upper guide portion 153A, which is provided upstream of the first die 161 in the conveyance direction and forms part of the conveyance route 105A, is arranged at a position downwardly deviated from the thermal insulating sheet 170. Therefore, the leading end of the sheet conveyed through the conveyance route 105A is less likely to collide with the thermal insulating sheet 170. This suppresses damage to the thermal insulating sheet 170 and a paper jam.

The stapling unit 101 for stapling a stack of a plurality of sheets is arranged downstream of the perforating device. Therefore, the friction force among a plurality of sheets is increased in a case in which water droplets are adhering to a sheet as compared with a case in which water droplets are not adhering to a sheet. Because adhesion of water droplets to a sheet passing through the punching unit 151 is suppressed, it facilitates a process of aligning ends of a plurality of sheets in the stapling unit 101. Therefore, in the stapling unit 101, it is possible to prevent degradation of accuracy for stapling a plurality of sheets.

### Modification Example

(1) Although having the two-layer structure of the thermal insulating layer 171 and the low-friction layer 173, the thermal insulating sheet 170 may have a single-layer structure made of a material having a friction coefficient smaller than that of a nonwoven fabric and thermal conductivity equal to or smaller than that of a nonwoven fabric. For example, a thermoplastic resin can be used.

(2) A thermal insulating material similar to the thermal insulating sheet 170 may be attached to the surface of the second die 163 facing the first die 161. Condensation on the second die 163 can be prevented.

(3) Although a sheet has been described as one example of a recording medium, a recording medium is not limited to a sheet. A recording medium may be an envelope formed of two overlapping sheets. Alternatively, a recording medium may be a medium formed of a material other than paper, such as an Over Head Projector (OHP) sheet.

(4) Although the stapling unit 101 has been described as one example of a processing device, a processing device is not limited to this. A processing device is only required to process a plurality of sheets. For example, a processing device may be a trimming device that trims a stack of a plurality of sheets, a sorter that sorts a plurality of sheets, or the like.

(5) While the punching unit 151 defines the relative position of a sheet with respect to the punching mechanism 160 using the restricting member 157 in the above-mentioned embodiment, the present invention is not limited to this. A sheet is only required to be positioned with respect to the punching mechanism 160 with a sheet being stopped in the conveyance route. For example, the relative position of a sheet with respect to the punching mechanism 160 may be defined by a roller that conveys a sheet, such as the forward-reverse roller 111.

Further, when the punching mechanism 160p perforates a sheet using the punching shaft 165, the second die 163 may be moved upwardly. Thus, a sheet can be held between the first die 161 and the second die 163, deviation of a perforation position can be suppressed.

(6) The thermal insulating sheet 170 is attached to the first die 161 of the punching unit 151 in the perforating device, by way of example. However, in a case in which a material having high thermal conductivity such as metal is used instead of the first die 161 in the conveyance route, the thermal insulating sheet 170 may be attached to the metal portion.

### Overview of Embodiment

(Item 1) A perforating device includes a punch die that forms part of a conveyance route through which a recording medium is conveyed, a punch provided to correspond to the punch die, and a thermal insulating sheet that covers at least part of a surface of the punch die.

According to this aspect, because at least part of the surface of the punch die is covered with the thermal insulating sheet, even in a case in which there is a difference between the temperature of the recording medium conveyed through the conveyance route and the temperature of the punch die, an occurrence of condensation on the surface of the punch die is suppressed. Thus, it is possible to provide the perforating device that suppresses adhesion of water droplets to a recording medium while suppressing an increase in size of the perforating device.

(Item 2) The perforating device according to item 1, wherein the recording medium heated by an image forming apparatus is conveyed through the conveyance route.

According to this aspect, the recording medium heated by the image forming apparatus is conveyed through the conveyance route. Water vapor may be generated from the heated recording medium. Because the thermal insulating sheet is provided between the recording medium and the punch die, condensation of water vapor is suppressed. This can suppress adhesion of water droplets to the recording medium heated by the image forming apparatus.

(Item 3) The perforating device according to item 1 or 2, wherein the punch die includes a first die, and a second die provided below the first die to be opposite to the first die, and the thermal insulating sheet covers at least part of a surface of the first die facing the second die.

According to this aspect, the punch die forming part of the conveyance route includes the first die, and the second die provided below the first die so as to be opposite to the first die. The thermal insulating sheet covers at least part of the surface of the first die facing the second die. Because water vapor generated from the recording medium is likely to move upwardly, the thermal insulating sheet is arranged on the first die located above the recording medium. Therefore, it is not necessary to arrange a thermal insulator in the second die. Thus, the configuration can be simplified, and the cost can be reduced.

(Item 4) The perforating device according to any one of items 1 to 3, wherein the thermal insulating sheet has a shape such that the farther a portion of the thermal insulating sheet is located upstream and away from the surface of the punch die in a conveyance direction in which the recording medium is conveyed, the farther the portion is located away from the surface in a direction orthogonal to the surface.

According to this aspect, the thermal insulating sheet has a shape such that the farther a portion of the thermal insulating sheet is located upstream and away from the surface of the punch die in the conveyance direction in which the recording medium is conveyed, the farther the portion is located away from the surface in a direction orthogonal to the surface. In a case in which the recording medium being conveyed enters the conveyance route formed of the punch die, the leading end of the recording medium may come into contact with the thermal insulating sheet. The thermal insulating sheet has a shape such that the farther a portion of the sheet insulating sheet is located upstream and away from the surface of the punch die in the conveyance direction, the farther the portion of the sheet insulating sheet is located away from the surface in a direction orthogonal to the surface. Therefore, in a case in which the recording medium comes into contact with the thermal insulating sheet, the resistance received from the thermal insulating sheet is reduced. This suppresses damage to the thermal insulating sheet. This suppresses jamming of the recording medium.

(Item 5) The perforating device according to any one of items 1 to 4, wherein the thermal insulating sheet covers an area other than a non-thermal insulating area, with the non-thermal insulating area including a hole of the surface of the punch die corresponding to the punch and a downstream portion located downstream of the hole in a conveyance direction of the recording medium.

According to this aspect, because the thermal insulating sheet does not cover the hole or the downstream portion, it is possible to suppress an occurrence of an event in which the recording medium is caught by the thermal insulating sheet. This can suppress jamming of the recording medium.

(Item 6) The perforating device according to any one of items 1 to 5, wherein the thermal insulating sheet has a two-layer structure in which a thermal insulating member, and a low friction member having a friction coefficient smaller than that of the thermal insulating member, are stacked.

According to this aspect, in a case in which the recording medium comes into contact with the thermal insulating sheet, the thermal insulating member can block heat, and the frictional resistance between the low-friction member and the recording medium can be reduced as much as possible.

(Item 7) The perforating device according to item 1, further includes a route forming section that is provided upstream of the punch die in a conveyance direction and forms part of the conveyance route, wherein the route forming section has a first conveyance surface and a second conveyance surface that face each other, and one of the first conveyance surface and the second conveyance surface that is arranged on a same side as the punch die is arranged at a position deviating from the thermal insulating sheet toward another side.

According to this aspect, one of the first conveyance surface and the second conveyance surface, which is arranged on the same side as the punch die, is arranged at a position deviating from the thermal insulating sheet toward the other side. Therefore, the leading end of the recording medium conveyed through the route forming section is less likely to collide with the thermal insulating sheet. This suppresses damage to the thermal insulating sheet.

(Item 8) A post-processing device includes the perforating device according to any one of items 1 to 7, and a processing device that is arranged downstream of the perforating device and processes a stack of a plurality of recording media.

According to this aspect, the stack of the plurality of recording media that has passed through the perforating device is processed by the processing device. In a case in which water droplets adhere to the recording medium, the frictional force among the recording media is increased as compared to a case in which water droplets do not adhere to the recording medium. Because adhesion of water droplets to the recording medium passing through the perforating device is suppressed, the relative positions of the plurality of recording media can be easily defined, and the accuracy for processing the stack of the plurality of recording media can be prevented from being degraded. As a result, it is possible to provide the post-processing device that suppresses degradation in processing accuracy.

(Item 9) An image forming system includes the post-processing device according to item 8, and an image forming apparatus arranged upstream of the perforating device, wherein the image forming apparatus includes an image forming section that forms an image on a recording medium, and a heating section that heats the recording medium on which an image is formed by the image forming section.

According to this aspect, it is possible to provide the image forming system that suppresses degradation of processing accuracy.

It should be understood that the embodiments disclosed herein are illustrative and non-restrictive in every respect. The scope of the present invention is defined not by the above description but by the appended claims and is intended to include any modifications within the scope and meaning equivalent to the appended claims.

Although embodiments of the present invention have been described and illustrated in detail, the disclosed embodiments are made for purpose of illustration and example only and not limitation. The scope of the present invention should be interpreted by terms of the appended claims.

What is claimed is:

1. A perforating device comprising:
a punch die that forms part of a conveyance route through which a recording medium is conveyed;
a punch provided to correspond to the punch die; and
a thermal insulating sheet that covers at least part of a surface of the punch die.

2. The perforating device according to claim 1, wherein
the recording medium heated by an image forming apparatus is conveyed through the conveyance route.

3. The perforating device according to claim 1, wherein
the punch die includes
a first die, and
a second die provided below the first die to be opposite to the first die, and
the thermal insulating sheet covers at least part of a surface of the first die facing the second die.

4. The perforating device according to claim 1, wherein
the thermal insulating sheet has a shape such that the farther a portion of the thermal insulating sheet is located upstream and away from the surface of the punch die in a conveyance direction in which the recording medium is conveyed, the farther the portion is located away from the surface in a direction orthogonal to the surface.

5. The perforating device according to claim 1, wherein
the thermal insulating sheet covers an area other than a non-thermal insulating area, with the non-thermal insulating area including a hole of the surface of the punch die corresponding to the punch and a downstream portion located downstream of the hole in a conveyance direction of the recording medium.

6. The perforating device according to claim 1, wherein
the thermal insulating sheet has a two-layer structure in which a thermal insulating member, and a low friction member having a friction coefficient smaller than that of the thermal insulating member are stacked.

7. The perforating device according to claim 1, further comprising a route forming section that is provided upstream of the punch die in a conveyance direction and forms part of the conveyance route, wherein
the route forming section has a first conveyance surface and a second conveyance surface that face each other, and
one of the first conveyance surface and the second conveyance surface that is arranged on a same side as the punch die is arranged at a position deviating from the thermal insulating sheet toward another side.

8. A post-processing device comprising:
the perforating device according to claim 1; and
a processing device that is arranged downstream of the perforating device and processes a stack of a plurality of recording media.

9. An image forming system comprising:
the post-processing device according to claim 8; and
an image forming apparatus arranged upstream of the perforating device, wherein
the image forming apparatus includes
an image forming section that forms an image on a recording medium, and
a heating section that heats the recording medium on which an image is formed by the image forming section.
